(19) United States
(12) Patent Application Publication
(10) Pub. No.: US 2012/0145628 A1
(43) Pub. Date: Jun. 14, 2012

(54) PHYTOREMEDIATION FOR DESALINATED WATER POST-PROCESSING

(76) Inventors: Yeal Ben Zvi, Tzipori (IL); Limor Gruber, Ramat Hasharon (IL); Dovrat Weizer, Ramat Hasharon (IL)

(21) Appl. No.: 13/388,598

(22) PCT Filed: Aug. 2, 2010
(86) PCT No.: PCT/IL10/00622

§ 371 Date: Mar. 2, 2012

Related U.S. Application Data
(60) Provisional application No. 61/230,711, filed on Aug. 2, 2009.
(60) Provisional application No. 61/361,951, filed on Jul. 7, 2010.

(51) Int. Cl. C02F 3/32

(52) U.S. Cl. 210/602; 210/170.01

(57) ABSTRACT

The present invention discloses a system for the production of enhanced water from desalinated water, the system consisting of: a desalinated water inlet for allowing the desalinated water to enter the system; a post inlet medium for prefiltering the desalinated water; a water enhancing assemblage of aquatic plants and microorganisms for enhancing the prefiltered desalinated water; a balance pit 5 for maintaining level of enhanced water; an enhanced water accumulation tank 6. The water is enhanced in that boron levels are decreased and levels of enzymes, secondary metabolites, vitamins, and minerals are increased.

### REFERENCE TO RELATED PUBLICATION

This application claims priority from U.S. provisional application 61/230,711 dated Aug. 2, 2009 and 61/361,951 of Jul. 7, 2010, which are hereby incorporated by reference in its entirety.

### FIELD OF THE INVENTION

The present invention relates to a device and method for phytoremediation of desalinated water, using constructed wetlands and bottled water derived therefrom.

### BACKGROUND OF THE INVENTION

Phytoremediation describes the treatment of environmental problems through the use of plants which mitigate the environmental problem without the need to remove the contaminant material and dispose of it elsewhere. Phytoremediation treatment can be in situ treatment, or at another site. Phytoextraction or phytoaccumulation refers to the use of plants for the removal of various factors from drinking water, soil, or the like. Constructed wetlands (CW) are often used for the purposes of phytoremediation, the process being referred to as phytoremediation/constructed wetlands or P/CW.

For example desalination of agricultural land by phytoextraction has a long tradition. The most common application for P/CW is treating sewage water. This application has been in use for at least the last 50 years. Another common use of P/CW known for the last 25 years is in natural swimming pools.

Use of P/CW for drinking water treatment has been disclosed in the art. For example CN11274798A discloses a “pretreatment method for drinking water source formed by connecting raw water, water transmission pipelines, a grit chamber, a subsurface artificial wetland with up and down baffling streams and a surface waveform artificial wetland”.

Similarly, CN11381186A “Multi-stage ecological purification technique of drinking water resource” discloses a multilevel ecological purifying technique for source drinking water comprising a settling tank, biochemical tank, artificial wetland and reservoir in a serial connection.

It is known that desalinated water commonly suffers from several problems such as high boron levels and depletion of nutrients, minerals and of other factors, and that current methods such as ion exchange are either energetically expensive, environmentally problematic, or both. Thus a method for phytoremediation of desalinated water fulfills a long felt need.

### BRIEF DESCRIPTION OF THE DRAWINGS

In order to understand the invention and to see how it may be implemented in practice, a plurality of embodiments will now be described, by way of non-limiting example only, with reference to the accompanying drawings, in which

FIG. 1 presents a basic diagram of a phytoremediation system of the prior art.

FIG. 2 pictorially presents a vertical constructed wetland.

FIG. 3 pictorially presents an horizontal constructed wetland.

FIG. 4 pictorially presents a tidal flow constructed wetland

FIG. 5 pictorially presents a free flow wetland

### SUMMARY OF THE INVENTION

The present invention comprises a system and method for phytoremediation in constructed wetlands. The invention treats environmental problems through the use of plants, plant substrates, and microorganisms, collectively known as bioremediation. The novelty of the invention relates to the implementation of these disciplines for desalinated water stabilization and improvement. Thus the aim of the present invention is not just to remove substances from the water but to add others that are important for water vitality, taste, anti fouling properties and sustainability. Phytoremediation processes are capable of enriching the desalinated water with vital elements deleted in the desalination processes or other “cleaning” processes. The combination of the enriched sediments, the microorganisms in the plants' rhizosphere and secondary metabolites emitted by the plants are able to vitalize the water, prevent operational problems like pipe corrosion, absorb the boron that is commonly found in desalinated water at high levels, and create environmentally friendly, tasteful water.

While the invention is susceptible to various modifications and alternative forms, specific embodiments thereof have been shown by way of example in the drawings and will herein be described in detail. It should be understood, however, that it is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF PREFERRED EMBODIMENTS

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a means and method for providing a waste water treatment system.

In the following detailed description, numerous specific details are set forth in order to provide a thorough understanding of embodiments of the present invention. However, those skilled in the art will understand that such embodiments may be practiced without these specific details. Reference throughout this specification to “one embodiment” or “an embodiment” means that a particular feature, structure, or characteristic described in connection with the embodiment is included in at least one embodiment of the invention.

Thus the present invention is directed to both a process of producing the water by providing a waste water treatment system and an article of manufacture; a tasteful and environmentally friendly bottled water product.

The term ‘calcium carbonate precipitation potential (CCPP)’ is defined as the quantity of calcium carbonate that can theoretically be precipitated from oversaturated waters or alternatively be dissolved into unsaturated waters.

The term ‘plurality’ refers hereinafter to any positive integer e.g, 1, 5, or 10.

The term ‘stage’ refers hereinafter to a unit adapted to perform a specific function such as filtration, sedimentation, addition of material, removal of material, and the like.

Constructed wetlands are artificial wetlands specifically designed to improve water quality. Like natural wetlands, they are a complex mixture of water, sediments, living and dead plant materials, fauna and microbes. In essence, constructed wetlands act as giant biogeochemical filters able to remove contaminants present at very low concentrations from very large volumes of wastewater (e.g., Se from oil refinery wastewater). The filtration of contaminants that occurs in a wetland ecosystem takes place mostly in the layer of dead, partially decomposed plants, known as fallen litter, and in the fine sediment layer beneath the litter layer. These two layers provide habitat for microbes and other organisms able to transform contaminants into less bio-available and therefore less toxic chemical forms. In addition to their role in generating the fallen litter and fine sediment layers, plants provide the fixed carbon that supports these microbial populations.

The present invention is a new concept for stabilization and improvement of post treatment desalinated water and otherwise damaged or deficient drinking water by means of phytoremediation in constructed wetlands (P/CW).

One problem specific to desalinated water is the depletion or elimination of minerals, enzymes, secondary metabolites and other substances vital to human, animal and plant well being, during the desalination process. The elimination of important substances, happens in varying degrees during other purification methods used for drinking water such as chlorination and Alumina flocculation.

A second problem is an excess of boron that is highly concentrated in the source sea water. High levels of boron are toxic—for example, irrigation with water containing more than 0.3 mg/l boron for long periods can be used as a sterilizing process.

Other operational problems in desalinated water systems such as corrosion of pipelines and red water phenomena also require a solution that may be adequately supplied by use of P/CW.

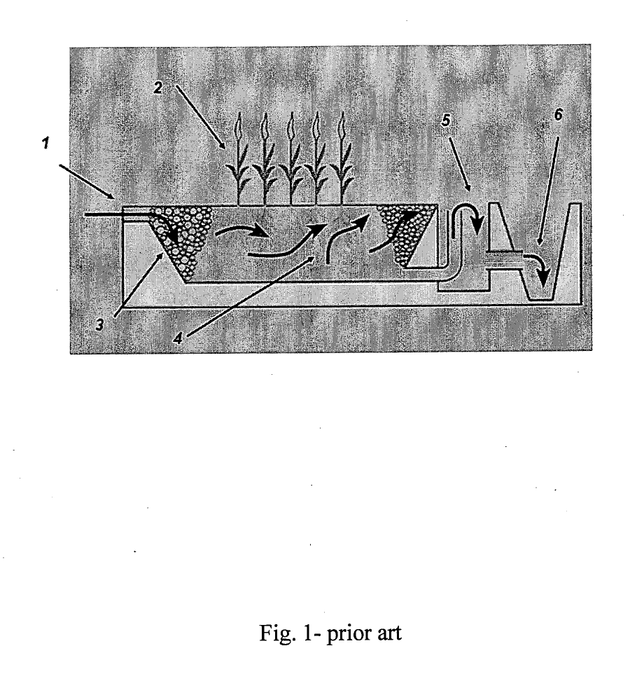

Reference is now made to FIG. 1, in which a schematic of a P/CW system is shown. The inflow of desalinated water 1 flows first through an enriched substrate 3 and then past a series of aquatic plant roots 4 whose leaves 2 project out of the water. The water then flows through a balance pit 5 and into an enhanced water accumulation tank 6. Thus the water flows into distribution areas and then through the substrate and root system. The water surface is below the substrate and it then passes from the collection area into the tank.

Subsurface-flow wetlands can be either horizontal flow or vertical flow constructed wetlands. In subsurface-flow wetlands effluent (agricultural or mining runoff, tannery or meat processing wastes, wastewater from sewage or storm drains, or other water to be cleansed) is moved through a gravel or other medium on which plants are rooted; The water effluent may move either horizontally, parallel to the surface, or vertically, from the planted layer down through the substrate and out.

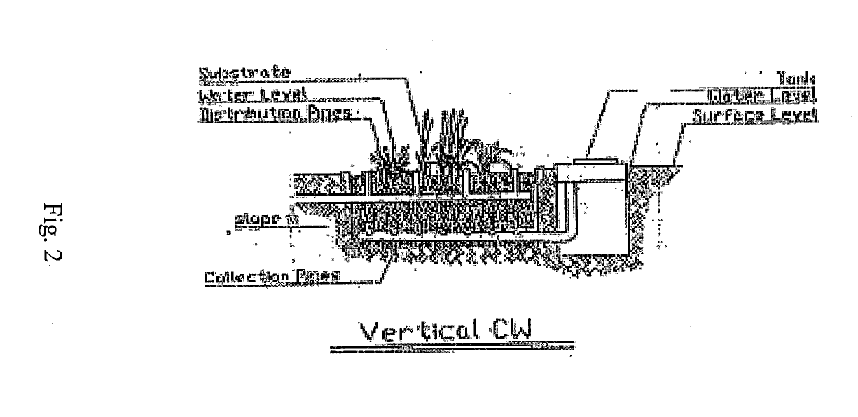

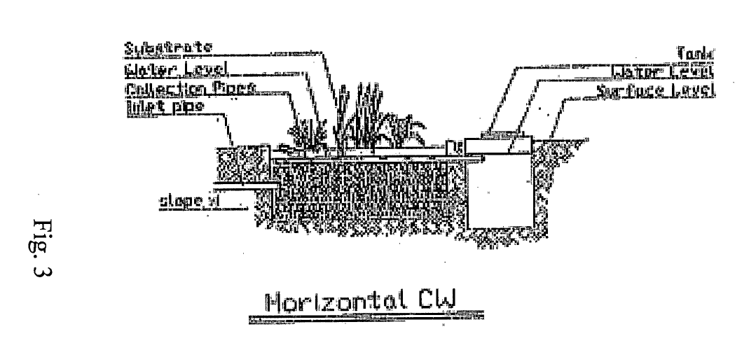

With reference to the drawings, FIG. 2 pictorially illustrates a vertical constructed wetland in which the effluent moves vertically from the planted layer through the distribution pipes and down through the substrate through the to the collection pipes. A mechanical dosing system or other mechanism, may be used to dose the wetland surface several times a day (e.g. 4 to 10 times a day), at a rate which allows the previous dose of water to percolate through the filter bed, allowing control over the aerobic conditions in the filter bed. The filter bed goes through stages of being saturated and unsaturated allowing different phases of aerobic and anaerobic conditions, as the water percolates through the filter bed, oxygen has time to diffuse through the media and fill the void spaces. In FIG. 3 a horizontal flow constructed wetland system is shown, in these systems the water enters at one end of a lined excavation and exits from the other end. A horizontal subsurface flow constructed wetland is a large gravel/other substance/sand-filled channel that is planted with aquatic vegetation. As water flows horizontally through the channel, entering through the inlet pipes the filter material filters out particles and microorganisms degrade organics, add anzyms and other secondary metabolites, and the treated water is collected into the collection pipes and through to the tank.

The water level in a horizontal subsurface flow constructed wetland is maintained at 5 to 15 cm below the surface to ensure subsurface flow. The bed should be wide and shallow so that the flow path of the water is maximized. A wide inlet zone should be used to evenly distribute the flow.

As water is not exposed in both horizontal and vertical subsurface flow wetlands, odours and mosquitoes are reduced, making them particularly suitable to domestic use.

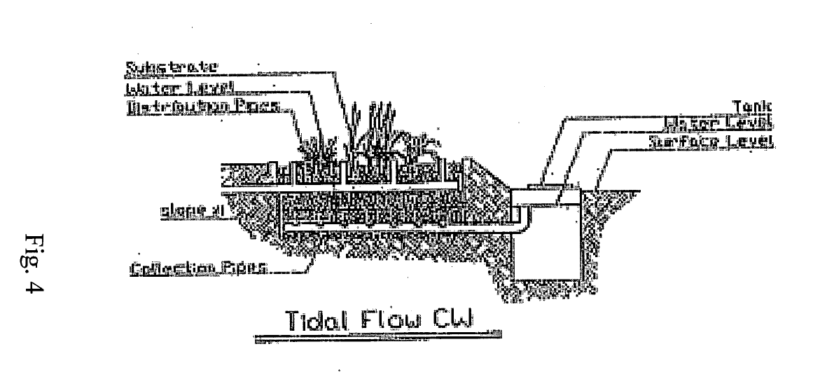

With reference to the figures, a tidal flow constructed wetland is illustrated in FIG. 4, in which a fill and drain sequence is used for batch treatment of water. During tidal flow operation, the wetland filter bed is alternately filled with water and drained. When being filled, air is repelled from the filter bed and when being drained, the retreating water acts as a passive pump to draw air from the atmosphere into the filter bed. Tidal flow constructed wetlands are very useful for certain applications such as nitrification and denitrification.

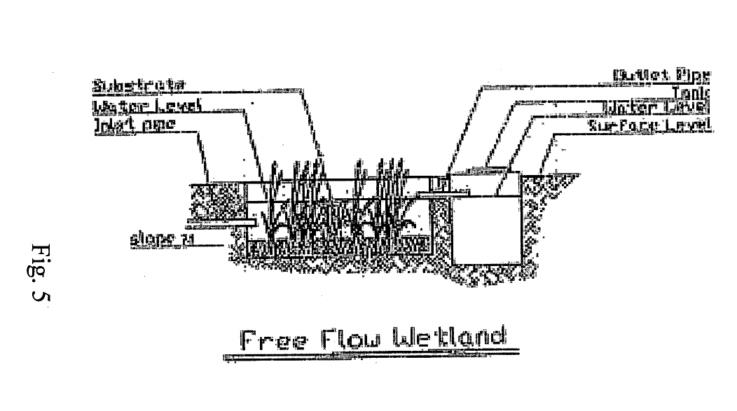

A free flow surface constructed wetland is shown in FIG. 5, free flow wetlands are the man-made equivalent of natural marshes, in which the water is above the filter bed allowing the creation of a wildlife habitat. As the effluent moves above the soil surface, rather than through the filter bed, a wider variety of soil types including bay mud and silty clays may be supported in this type of CW. The effluent water moving above the ground is exposed to the atmosphere and direct sunlight, water is flooded onto the surface of the wetland through well spaced inlets so that the effluent water reaches a depth of 10 to 100 cm above the ground. As the water slowly flows through the wetland, simultaneous physical, chemical and biological processes filter out the solids, degrade organic waste and nutrients are removed from the effluent to be used by plants and other organisms in the CW environment. Once in the pond, the heavier sediment particles settle out, also removing nutrients that are attached to particles. Plants, and the communities of microorganisms that they support (on the stems and roots), take up nutrients like nitrogen and phosphorus. Chemical reactions may cause other elements to precipitate out of the wastewater. Pathogens are removed from the water by natural decay, predation from higher organisms, sedimentation and

UV irradiation. Although the soil layer below the water is anaerobic, the plant roots exude (release) oxygen into the area immediately surrounding the root hairs, thus creating an environment for complex biological and chemical activity. An outlet pipe then collects the treated water into a tank on the other side of the wetland.

The processes that take place in the system are chemical processes of absorption in the sediments, enhancement of vital substances emitted by plants through the rhizosphere's microbial activity and in addition, adsorption and absorption processes are carried out by the plants themselves.

In broad overview, the water outflow of a desalination process such as seawater reverse osmosis (SWRO) or other source for drinking water enters a closed system of sealed ponds filled with dolomites, basalt, expended clay substrates and some organic matter, specific to the source water in which aquatic plants are planted in series. These plants are arranged in such a way to enable the flow to pass through a maximum of different substrate areas and plant rhizospheres.

The system may be modified by changing the size of the P/CW in a modular fashion to work at various flow rates, from minor local systems with flow capacities of 20 cubic meters per day to national systems with flow capacity of up to 500,000 cubic meters per day.

The construction details of the invention as shown in FIG. 1 are derived and based on the known principles of constructed wetland. The novel step of the current invention lies in the innovative application for desalinated water and for other sources of drinking water, enhancement and stabilization. The variety of substrates, water flows and plants will differ according to place, climate and regulation requirements as will be obvious to one skilled in the art.

The advantages of the present invention include, without limitation—
The use of natural biological systems instead of chemical systems, with no residual outputs that are harmful to the environment.
Minimum energy consumption—the system works passively, with flow provided by gravitation.
The system can be located near the desalination plant, or water source, or in a distant area, transporting the water in pipelines.
In terms of cost/benefit the total operational and construction costs are lower than the existing solutions.
Maintenance costs are extremely low.
No pollution is emitted from the system.
Water is enriched with vital elements.
Water taste is considerably improved.

In broad terms, the present invention comprises a sustainable system, adapted to perform post treatment of desalinated water and other sources of drinking water. The invention comprises a cost effective system that is environmentally friendly, modular, and that is able to produce life supporting water.

Water enhanced in this fashion enjoys replenishment of metabolites, vitamins, enzymes, and other factors.

Current water sources have increasing levels of fats, salts, heavy metals, radioactive materials from industrial or municipal sources, pathogenic bacteria, hormones, pesticides, and other compounds. These compounds deleteriously affect the population in ways and with a magnitude that is only now beginning to be understood. Many of these compounds are not removed by standard water purification processes and thus remain in the water cycle indefinitely. Thus a method for purification of these substances is of vital importance. A number of methods having various effects are known, such as microfiltration, absorption e.g. in alumina or activated carbon, chlorine sterilization, desalination, UV sterilization, electrolysis, and others. None of these methods solves the wide variety of contamination problems now encountered, and neither do they replenish other useful compounds that are in many cases depleted in drinking water sources.

Drinking water standards abound, often specifying levels of nitrates, phosphates, pathogens, and minimum mineral levels (for drinking water). However, there are no known standards for factors in biologically enhanced water. As a result of P/CW treatment, water takes part in metabolic processes of plants and bacteria that enrich the water with enzymes, secondary metabolites, vitamins, and minerals. In addition, pollutants not recognized by various water quality standards (such as hormones) are broken down biologically to intermediate products or inactive materials of no biological import. Enzymes are catalysts for metabolic and other life processes. Most enzymes are proteins and thousands are found in living cells, which, cannot survive in their absence. The enzymes facilitate reactions by catalysis which increases reaction rates by several orders of magnitude. Enzymatic action is effected mainly by temperature, pH, ion concentration, and substrate properties. Plants and microorganisms emit enzymes to their surroundings as a natural part of their continued existence. Amongst the enzymes emitted are oxidoreductases, hydrolases, and others which break down nutrients in the water and change their form such that they are available for biological processes.

Secondary metabolites are natural metabolites that are created or emitted in the primary metabolic process, and generally comprise relatively small molecules. These secondary metabolites have several roles: defense against pathogens, increase of competitive advantages, hormonal signals, and the like. There are at this point 200,000 known, naturally occurring small molecules produced by the plant world, only a small part of which have been studied with respect to their metabolic roles.

A small number of these secondary metabolites are included in the category of food additives found to have beneficial effects on human beings particularly and living organisms in general. For example, antioxidants such as reserveteral, vitamin C, lycophin, and others are included in this category. In addition about 25% of all medicines in the market are produced from plant sources. These are used for anti-cancer treatments, such as Taxol used for chemotherapy. Some secondary metabolites are absorbed into the bloodstream upon ingestion and take part in bodily processes and/or are taken up into cells. Some have positive effects upon the cell, and thus ingestion of water enhanced by plants such as in constructed wetlands, can be expected to have positive effects on the blood.

Vitamins are produced by micro-organismic excretions. Minerals are found in high levels in water enhanced by P/CW, including iron, calcium, and magnesium. It is within the provision of the invention to provide defined levels of various concentrations in the desalinated water so enhanced. In particular alkalinity of greater than 80 mg/L, Ca2+ concentration between 80 and 120 mg/L, Calcium carbonate precipitation potential (CCPP) between 3 and 10, and pH less than 8.5.

A national primary drinking water standard of the US EPA is listed for example at http://www.epa.gov/safewater/contaminants/index.html; it is within provision of the invention to provide water consistent with this standard.

A US national secondary drinking water standard is listed below; it is within provision of the invention to provide water consistent with this standard. (Since we are dealing with biological process, we believe we can reach this level with the process but the dosage of the elements will be derived from the biological process and not from measurements. Therefore we can not commit exactly to these amounts.

| Contaminant | Secondary Standard | |
|---|---|---|
| Aluminum | 0.05 to 0.2 | mg/L |
| Chloride | 250 | mg/L |
| Color | 15 | (color units) |
| Copper | 1.0 | mg/L |
| Corrosivity | noncorrosive | |
| Fluoride | 2.0 | mg/L |
| Foaming Agents | 0.5 | mg/L |
| Iron | 0.3 | mg/L |
| Manganese | 0.05 | mg/L |
| Odor | 3 threshold odor | |
| | number | |
| pH | 6.5-8.5 | |
| Silver | 0.10 | mg/L |
| Sulfate | 250 | mg/L |
| Total Dissolved | 500 | mg/L |
| Solids | | |
| Zinc | 5 | mg/L |

It is within the provision of the invention to treat water such that:
Acrylamide levels are reduced to 0.05% or less
Epichlorohydrin is reduced to 0.01% or less
Giardia lamblia: 99.9% killed/inactivated
Viruses: 99.99% killed/inactivated
Turbidity less than 5 nephelolometric turbidity units

1-36. (canceled)

37. A system for the production of enhanced water from desalinated water, said system consisting of:
a desalinated water inlet for allowing said desalinated water to enter said system;
a post inlet medium for pre-treating said desalinated water;
a water enhancing assemblage of aquatic plants and microorganisms for enhancing said pre-treated desalinated water;
a balance pit for maintaining level of enhanced water, and;
an enhanced water accumulation tank;
wherein said water is enhanced in that boron levels are decreased and levels of enzymes, secondary metabolites, vitamins, and minerals are increased.

38. The system of claim 1 wherein said enhanced water is characterized by an alkalinity of greater than 80 mg/L, Ca2⁺ concentration between 80 and 120 mg/L, calcium carbonate precipitation potential between 3 and 10, and pH less than 8.5.

39. The system of claim 37 wherein said plants are selected from the group consisting of: Cyperus, Scirpus, Canna, Zantandeschia, Typha Arundo, Phragmatys, Eleocharis, Phalaris, Iris, Alpinia, Juncus, Lytrum, Collocasia, sagitaria, Hydrocotyle, Bacopa, Marcilea, Egeria, Myriophyllum, and other known wetland plants.

40. The system of claim 37, wherein said system is provided with an additional stage selected from the group consisting of: sedimentation stage, filtration stage, chemical precipitation stage, flocculation stage, settling stage, centrifugation stage, mechanical straining, fermentation stage, UV irradiation stage, adsorption stage, microbial biofilm interactions stage, chemical uptake by vegetation stage, and chemical release by vegetation stage.

41. The system of claim 37, wherein said constructed wetland is provided with deep zones and water meadow zones.

42. The system of claim 37, wherein said enhanced water is bottled in a material selected from the group consisting of: plastic, glass, composite, metal for transport and use such that said enhanced water meets or exceeds the US EPA national primary drinking water standard and/or the US EPA secondary drinking water standard; wherein said enhanced water contains between 0.05 and 0.2 mg/L aluminum, 250 mg/L chloride or less, 15 color units, 1 mg/L copper or less, is noncorrosive, contains 2 mg/L fluoride or more, 0.5 mg/L foaming agents or less, 0.3 mg/L iron or more, 0.05 mg/L manganese or more, has 3 threshold odor number, has a pH of 6.5-8.5, 0.1 mg/L silver, 250 mg/L sulfate or less, 500 mg/L total dissolved solids or less, and 5 mg/L zinc or more.

43. The system of claim 37, wherein said enhanced water is bottled in a material selected from the group consisting of: plastic, glass, composite, metal for transport and use such that said enhanced water meets or exceeds the US EPA national primary drinking water standard and/or the US EPA secondary drinking water standard; wherein said enhanced water contains less than 3 μg/l 1,2 dicholoroethane, 200 μg/aluminum, 0.5 mg/l ammonium, 5 μg/antimony, 10 μg/l arsenic, 1 μg/benzene, 0.01 μg/l benzoapyrene, 10 μg/boron, μg/l bromated, 5 μg/l cadmium, 250 mg/l chloride, 50 μg/chromium, 0 clostridium perfringens per 100 ml, 0 coliform bacteria per 100 ml, no abnormal colony count, 20 mg/l Pt/Co scale color, 2500 mS/cm at 20 C conductivity, 2 mg/l copper, 50 μg/cyanide, 0 E. coli and enterococci per 100 ml, 1.5 mg/l fluoride, 0.1 Bq/l gross alpha activity, 1 Bq/l gross beta activity, 10 μg/l lead, 200 μg/iron, 50 μg/manganese, 1 μg/ml mercury, 20 μg/nickel, 50 mg/l nitrate, 0.5 mg/l nitrite, 0.1 μg/l polyaromatic hydrocarbons, 0.1 μg/l persticides, pH 6/5-9.5, 10 μg/selenium, 200 mg/l sodium, 10 μg/solvents, 250 mg/l sulphate, 3 μg/l tetrachloromethane, total indicative radiation does 0.1 mSv/uyear, total trihalomethanes 100 μg/l, 100 Bq/l tritium, 4NTU turbidity.

44. The system of claim 37, wherein at least one of the following holds true;
said enhanced water contains trace elements chromium, zinc, manganese, vanadium, fluorine, silicon, and copper at levels greater than 1 μg/l,
said enhanced water contains trace elements cadmium, lead, mercury, cobalt, and selenium at levels less than 0.1 μg/l; or
said enhanced water contains secondary metabolites selected from the group consisting of: reserveteral, vitamin C, lycophin; wherein said enhanced water contains vitamins selected from the group consisting of: vitamin B, vitamin C, thiamin, riboflavin, niacin, pyridoxine, folic acid.

45. A method for the treatment of desalinated water consisting of the steps of:
providing a constructed wetland consisting of a desalinated water inlet, a porous inlet medium through which said desalinated water is conducted, a plurality of aquatic plants and microorganisms, a balance pit, and an enhanced water accumulation tank, and;
conducting desalinated past said constructed wetland,
whereby boron levels are decreased and levels of enzymes, secondary metabolites, vitamins, and minerals are increased by said method.

46. The method of claim 45, wherein the enhanced water is characterized by an alkalinity of greater than 80 mg/L, Ca2⁺ concentration between 80 and 120 mg/L, Calcium carbonate precipitation potential between 3 and 10, and pH less than 8.5.

47. The method of claim 45, wherein said plants are selected from the group consisting of: Cyperus, Scirpus, Canna, Zantandeschia, Typha Arundo, Phragmatys, Eleocharis, Phalaris, Iris, Alpinia, Juncus, Lytrum, Collocasia, sagitaria, Hydrocotyle, Bacopa, Marcilea, Egeria, Myriophyllum, and other known wetland plants, halophytes, and hyperaccumulator plants.

48. The method of claim 45, including provision for processes selected from the group consisting of: sedimentation, filtration, chemical precipitation and adsorption, microbial biofilm interactions, uptake by vegetation, and release by vegetation.

49. The method of claim 45, wherein said constructed wetland consisting of a desalinated water inlet, a porous inlet medium through which said desalinated water is conducted, a plurality of aquatic plants and microorganisms including Arabidopsis, a balance pit, and an enhanced water accumulation tank, is provided with deep zones and water meadow zones.

50. The method of claim 45, wherein said enhanced water is bottled for transport and use such that said enhanced water meets or exceeds the US EPA national primary drinking water standard and/or the US EPA secondary drinking water standard; wherein enhanced water contains between 0.05 and 0.2 mg/L aluminum, 250 mg/L chloride or less, 15 color units, 1 mg/L copper or less, is noncorrosive, contains 2 mg/L fluoride or more, 0.5 mg/L foaming agents or less, 0.3 mg/L iron or more, 0.05 mg/L manganese or more, has 3 threshold odor number, has a pH of 6.5-8.5, 0.1 mg/L silver, 250 mg/L sulfate or less, 500 mg/L total dissolved solids or less, 5 mg/L zinc or more.

51. The method of claim 45, wherein said enhanced water is bottled for transport and use such that said enhanced water meets or exceeds the US EPA national primary drinking water standard and/or the US EPA secondary drinking water standard; wherein said enhanced water contains less than 3 μg/l 1,2 dicholoroethane, 200 μg/aluminum, 0.5 mg/l ammonium, 5 μg/antimony, 10 μg/l arsenic, 1 μg/benzene, 0.01 μg/l benzoapyrene, 10 μg/boron, μg/l bromated, 5 μg/l cadmium, 250 mg/l chloride, 50 μg/chromium, 0 clostridium perfringens per 100 ml, 0 coliform bacteria per 100 ml, no abnormal colony count, 20 mg/l Pt/Co scale color, 2500 mS/cm at 20 C conductivity, 2 mg/l copper, 50 μg/cyanide, 0 E. coli and enterococci per 100 ml, 1.5 mg/l fluoride, 0.1 Bq/l gross alpha activity, 1 Bq/l gross beta activity, 10 μg/l lead, 200 μg/iron, 50 μg/manganese, 1 μg/ml mercury, 20 μg/nickel, 50 mg/l nitrate, 0.5 mg/l nitrite, 0.1 μg/l polyaromatic hydrocarbons, 0.1 μg/l persticides, pH 6/5-9.5, 10 μg/selenium, 200 mg/l sodium, 10 μg/solvents, 250 mg/l sulphate, 3 μg/l tetrachloromethane, total indicative radiation doe 0.1 mSv/uyear, total trihalomethanes 100 μg/l, 100 Bq/l tritium, 4NTU turbidity.

52. The use of phytoremediation to enhance and stabilize desalinated water wherein said use comprises:
a desalinated water inlet;
a post inlet medium for pre-treating said desalinated water;
a water enhancing assemblage of aquatic plants and microorganisms for enhancing said pre-treated desalinated water;
a balance pit for maintaining level of enhanced water, and;
an enhanced water accumulation tank.

53. The method of claim 45, additionally comprising step of providing said enhanced water with proteins; said proteins are extracellular enzymes adapted to assist in hydrolysis of high molecular weight organic matter; wherein said enzymes are obtained by at least one selected from a group consisting of microbes, aquatic plants or any combination thereof.

54. The method of claim 45, additionally comprising step of selecting said extracellular enzymes from a group consisting of hydrolases such as cellulases, proteases, phosphatases, non-hydrolitic enzymes such as oxidoreductases, catalases, polyphenoloxidase, peroxidases or any combination thereof.

55. The method of claim 45, wherein at least one of the following holds true;
said enhanced water contains trace elements chromium, zinc, manganese, vanadium, fluorine, silicon, and copper at levels greater than 1 μg/l,
said enhanced water contains trace elements cadmium, lead, mercury, cobalt, and selenium at levels less than 0.1 μg/l;
said enhanced water contains secondary metabolites selected from the group consisting of: reserveteral, vitamin C, lycophin or any other antioxidant.

56. The method of claim 45, wherein at least one of the following holds true;
said enhanced water contains vitamins selected from the group consisting of: vitamin B, vitamin C, thiamin, riboflavin, niacin, pyridoxine, folic acid; wherein said enhanced water contains enzymes selected from the group consisting of: folic acid, amylase, protease, endohydrolase, endohydrolase, glucosidase;
said enhanced water contains antioxidants selected from the group consisting of: glutathione, vitamin C, vitamin E, catalase, superoxide dismutase, and peroxidases.
